(19) United States
(12) Patent Application Publication
(10) Pub. No.: US 2004/0139111 A1
(43) Pub. Date: Jul. 15, 2004

(54) Methods and apparatus for data validation and transformation

(76) Inventors: Chad A. Schoettger, Louisville, CO (US); Paul E. Andrighetti, Thornton, CO (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 10/341,623

(22) Filed: Jan. 14, 2003

(51) Int. Cl. G06F 17/00

(52) U.S. Cl. 707/104.1

(57) ABSTRACT

Disclosed are novel methods and apparatus for provision of efficient, effective, and/or flexible data validation and/or transformation. In accordance with an embodiment of the present invention, a computer system for providing courseware data is disclosed. The computer system includes: a client apparatus to provide a customer data file; an LMS server to store the courseware data and receive the customer data file, the LMS server and the client apparatus communicating through a communication channel; and a customer information repository to store data corresponding to a customer ELP version and a customer ID, the customer information repository being accessible by the LMS server. In another embodiment of the present invention, a data field associated with the customer data file may be parsed to determine an output format corresponding to the customer ELP version and the customer ID.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The following notice applies to the software and data as described below and in the drawings hereto: Copyright @ 2002-2003, Sun Microsystems, Inc., All Rights Reserved.

### FIELD OF INVENTION

The present invention generally relates to the field of data handling. More specifically, an embodiment of the present invention provides for data validation and/or transformation.

### BACKGROUND OF INVENTION

As the number of computers increases worldwide, so does their use in educational settings. Many classrooms and libraries now provide access to data that may be located halfway around the world. Instead of a student having to be physically present in a class, the student may now attend a class by utilizing a computer thousands of miles away. In addition, training materials can be stored on computers (i.e., digitized) for use at a later time or while mobile.

Computer-based training materials are, however, largely developed on a proprietary (e.g., company-by-company) basis, resulting in high development costs and limited resale value. American companies alone spend billions of dollars a year on the development of training products with little of the investment focused on resale or external product development. To obviate these problem, the advanced distributive learning (ADL) initiative has been developing guidelines to create new markets for training materials, reduce the costs of development, and increase the potential return on investment. Further information regarding ADL may be found by reference to www.adlnet.org.

One common way to share educational information is to utilize a learning management system (LMS). An LMS generally includes solutions for cataloging, course registration, provision of a course, tracking (for example, by managers), and accounting. When deploying an enterprise-level learning platform (such as an LMS) to new and existing customer sites, it is often necessary to load large amounts of the customer's data into the LMS.

The data must then be formatted by the customer to conform to the most recent version of LMS data loading tools. If the loading tool's input format changes (e.g., by adding or deleting data fields or lengths), the customer must then modify the data format they provide to the loader tools or the loading process will fail. This can be a time-consuming, frustrating and error prone process for the customer.

### SUMMARY OF INVENTION

The present invention, which may be implemented utilizing a general-purpose digital computer, in certain embodiments of the present invention, includes novel methods and apparatus to provide efficient, effective, and/or flexible data validation and/or transformation. In accordance with an embodiment of the present invention, a computer system for providing courseware data is disclosed. The computer system includes: a client apparatus to provide a customer data file; an LMS server to store the courseware data and receive the customer data file, the LMS server and the client apparatus communicating through a communication channel; and a customer information repository to store data corresponding to a customer ELP version and a customer ID, the customer information repository being accessible by the LMS server.

In another embodiment of the present invention, a data field associated with the customer data file may be parsed to determine an output format corresponding to the customer ELP version and the customer ID.

In a further embodiment of the present invention, a method of providing courseware data is disclosed. The method includes: receiving a data file from a customer, the customer data including the courseware data; parsing a data field associated with the data file; looking up customer data associated with the parsed data field in a customer information repository, the customer information repository storing customer data corresponding to a customer ELP version and a customer ID; verifying data stored in the data file; determining an output format corresponding to the customer ELP version and the customer ID; and generating an output by applying the determined output format to the customer data file.

### BRIEF DESCRIPTION OF DRAWINGS

The present invention may be better understood and its numerous objects, features, and advantages made apparent to those skilled in the art by reference to the accompanying drawings in which:

FIG. 1 illustrates an exemplary computer system 100 in which certain embodiments of the present invention may be implemented;

FIG. 2 illustrates an exemplary block diagram of a system 200 in accordance with an embodiment of the present invention; and

FIG. 3 illustrates an exemplary block diagram of a method 300 in accordance with an embodiment of the present invention.

The use of the same reference symbols in different drawings indicates similar or identical items.

### DETAILED DESCRIPTION

In the following description, numerous details are set forth. It will be apparent, however, to one skilled in the art that embodiments of the present invention may be practiced without these specific details. In other instances, well-known structures, devices, and techniques have not been shown in detail, in order to avoid obscuring the understanding of the description. The description is thus to be regarded as illustrative instead of limiting.

Reference in the specification to “one embodiment” or “an embodiment” means that a particular feature, structure, or characteristic described in connection with the embodiment is included in at least an embodiment of the invention. The appearances of the phrase “in one embodiment” in various places in the specification are not necessarily all referring to the same embodiment.

Also, select embodiments of the present invention include various operations, which are described herein. The operations of the embodiments of the present invention may be performed by hardware components or may be embodied in machine-executable instructions, which may be in turn utilized to cause a general- purpose or special-purpose processor, or logic circuits programmed with the instructions to perform the operations. Alternatively, the operations may be performed by a combination of hardware and software.

Moreover, embodiments of the present invention may be provided as computer program products, which may include machine-readable medium having stored thereon instructions used to program a computer (or other electronic devices) to perform a process according to embodiments of the present invention. The machine-readable medium may include, but is not limited to, floppy diskettes, optical disks, compact disc-read only memories (CD-ROMs), and magneto-optical disks, read-only memories (ROMs), random-access memories (RAMs), erasable programmable ROMs (EPROMs), electrically EPROMs (EEPROMs), magnetic or optical cards, flash memory, or other types of media or machine-readable medium suitable for storing electronic instructions and/or data.

Additionally, embodiments of the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

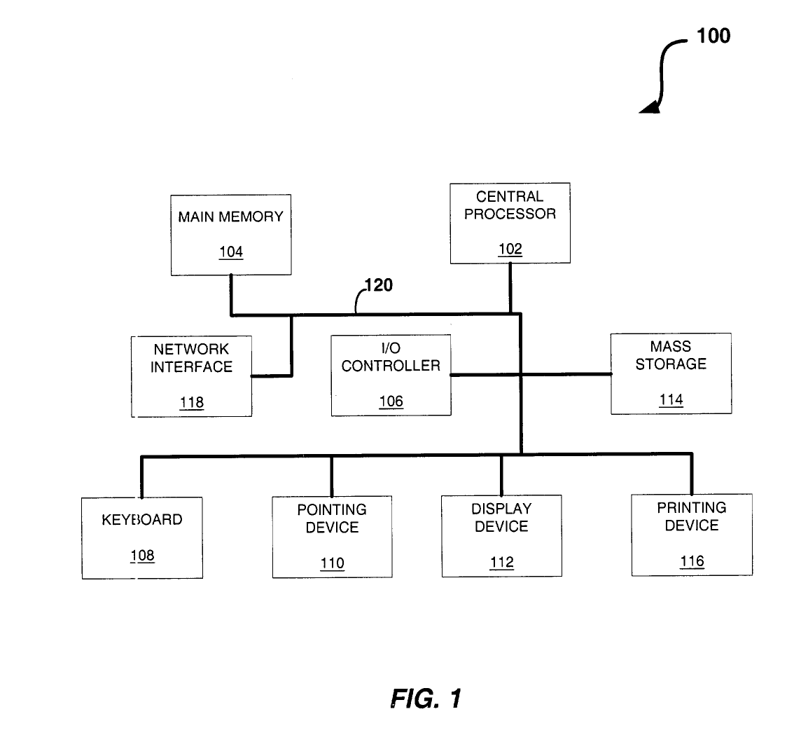

FIG. 1 illustrates an exemplary computer system 100 in which certain embodiments of the present invention may be implemented. The system 100 comprises a central processor 102, a main memory 104, an input/output (I/O) controller 106, a keyboard 108, a pointing device 110 (e.g., mouse, track ball, pen device, or the like), a display device 112, a mass storage 114 (e.g., a nonvolatile storage such as a hard disk, an optical drive, and the like), and a network interface 118. Additional input/output devices, such as a printing device 116, may be included in the system 100 as desired. As illustrated, the various components of the system 100 communicate through a system bus 120 or similar architecture.

In accordance with an embodiment of the present invention, the computer system 100 includes a Sun Microsystems computer utilizing a SPARC microprocessor available from several vendors (including Sun Microsystems, Inc., of Santa Clara, Calif.). Those with ordinary skill in the art understand, however, that any type of computer system may be utilized to embody the present invention, including those made by Hewlett Packard of Palo Alto, Calif., and IBM-compatible personal computers utilizing Intel microprocessor, which are available from several vendors (including IBM of Armonk, N.Y.). Also, instead of a single processor, two or more processors (whether on a single chip or on separate chips) can be utilized to provide speedup in operations. It is further envisioned that the processor 102 may be a complex instruction set computer (CISC) microprocessor, a reduced instruction set computing (RISC) microprocessor, a very long instruction word (VLIW) microprocessor, a processor implementing a combination of instruction sets, and the like.

The network interface 118 provides communication capability with other computer systems on a same local network, on a different network connected via modems and the like to the present network, or to other computers across the Internet. In various embodiments of the present invention, the network interface 118 can be implemented utilizing technologies including, but not limited to, Ethernet, Fast Ethernet, Gigabit Ethernet (such as that covered by the Institute of Electrical and Electronics Engineers (IEEE) 801.1 standard), wide-area network (WAN), leased line (such as T1, T3, optical carrier 3 (OC3), and the like), analog modem, digital subscriber line (DSL and its varieties such as high bit-rate DSL (HDSL), integrated services digital network DSL (IDSL), and the like), cellular, wireless networks (such as those implemented by utilizing the wireless application protocol (WAP)), time division multiplexing (TDM), universal serial bus (USB and its varieties such as USB II), asynchronous transfer mode (ATM), satellite, cable modem, and/or FireWire.

Moreover, the computer system 100 may utilize operating systems such as Solaris, Windows (and its varieties such as CE, NT, 2000, XP, ME, and the like), HP-UX, IBM-AIX, PALM, UNIX, Berkeley software distribution (BSD) UNIX, Linux, Apple UNIX (AUX), Macintosh operating system (Mac OS) (including Mac OS X), and the like. Also, it is envisioned that in certain embodiments of the present invention, the computer system 100 is a general purpose computer capable of running any number of applications such as those available from companies including Oracle, Siebel, Unisys, Microsoft, and the like.

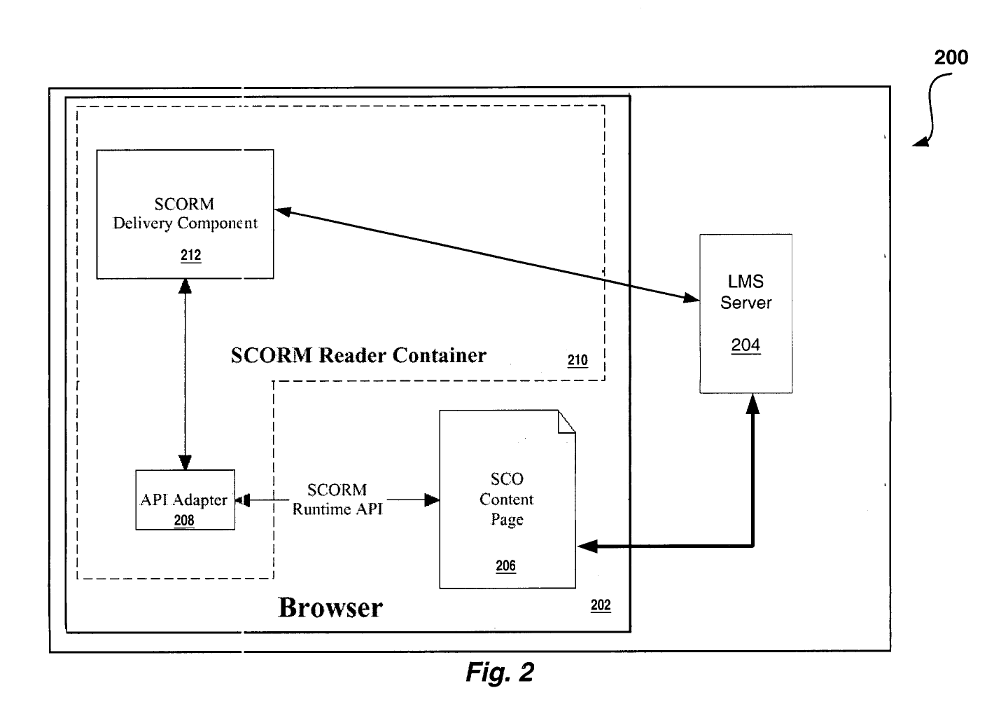

FIG. 2 illustrates an exemplary block diagram of a system 200 in accordance with an embodiment of the present invention. In one embodiment, the arrows in FIG. 2 indicate the direction of information flow. It is, however, envisioned that the information may flow in various directions, for example, depending on the specific implementation, with the attainment of all or some of the advantages. The system 200 includes a browser 202 which may have access to an LMS server 204. The LMS server 204 may provide various resources (not shown) such as access to a sharable content object (SCO) content database, a course tracking service (e.g., to keep track of a student's progress), a learner profile service (e.g., to maintain a profile of each student), a course administration service, a testing/assessment service, a sequencing service (to order the course content), a content management service, a cataloging service, a course registration service, an accounting service, and the like.

Generally, a database as used herein is envisioned to include any collection of data that is organized for collection and/or retrieval. A SCO generally represents a collection of one or more assets that include a specific launchable asset that utilizes the sharable content object reference model (SCORM) runtime environment to communicate with an LMS. More specifically, a SCO represents the lowest level of granularity of learning resources that can be tracked by an LMS using the SCORM runtime environment. The SCORM standard is hereby incorporated herein by reference. SCORM provides a reference model that defines a Web-based learning content model. Moreover, SCORM provides a set of interrelated technical specifications designed to meet the Department of Defense's high-level requirements. Further information regarding the SCORM standard may be found by reference to www.adlnet.org.

In an embodiment, the browser 202 may be selected from any available browsers such as the Internet Explorer available from Microsoft Corporation of Redmond, Washington, and the Netscape Navigator available through Sun One (formerly iPlanet, now a division of Sun Microsystems, Inc., of Santa Clara, Calif.). The browser 202 includes a SCO content page 206 which can display content obtained, for example, from the LMS server 204. The browser 202 further includes an application programming interface (API) adapter 208 which may receive SCORM compliant information and/or requests (e.g., through a SCORM runtime API) from the SCO content page 206. The requests may include initialize and finish requests, for example, signifying the start and end of that SCO's content delivery. The requests may also include get and/or set requests for the specific data defined in the SCORM runtime data model, for example.

The browser 202 may additionally include a SCORM reader container 210, which is capable of communicating with the API adapter 208. In an embodiment, the SCORM reader container 210 may be implemented as an applet or a signed applet. A signed applet will be beneficial when, for example, a mechanism is required to read and/or write to a user's hard drive. Generally, applets are not allowed to read/write from a local disk, unless the respective applet is either signed or its code is located in the browser's class path, for example. The SCORM reader container 210 includes a SCORM delivery component 212 which may receive information from the API adapter 208. In one embodiment, the API adapter 208 is envisioned to perform appropriate formatting and/or translation of information communicated between the SCORM runtime API and the LMS server 204. The SCORM reader container 210 may further communicated with the LMS server 204 (directly or via other modules (not shown)).

In one embodiment, the SCORM reader container 210 may be implemented in Java or other appropriate programming environments. In one embodiment, the API adapter 208 may include seven methods as defined by the ADL. The LMS server 204 may store data indicating SCORM information that a user has already viewed, the user's exit status, and/or a SCO's status on exit. This is, for example, very helpful to bring a user back to where that user had previously left off. Therefore, an embodiment of the present invention will capture and persist all of the mandatory data defined in the SCORM runtime data model in, for example, the LMS server 204.

Accordingly, an embodiment of the present invention provides the SCORM delivery component 212, which displays courseware in a browser window in accordance with the SCORM standard. The courseware may include tests and/or general teaching data. The SCORM delivery component 212 may receive requests from the SCO content page 206 (through, for example, the API adapter 208) and obtain appropriate SCORM-based information from the LMS server 204. The SCORM delivery component 212 may store information regarding the user's progress in the LMS server for future reference.

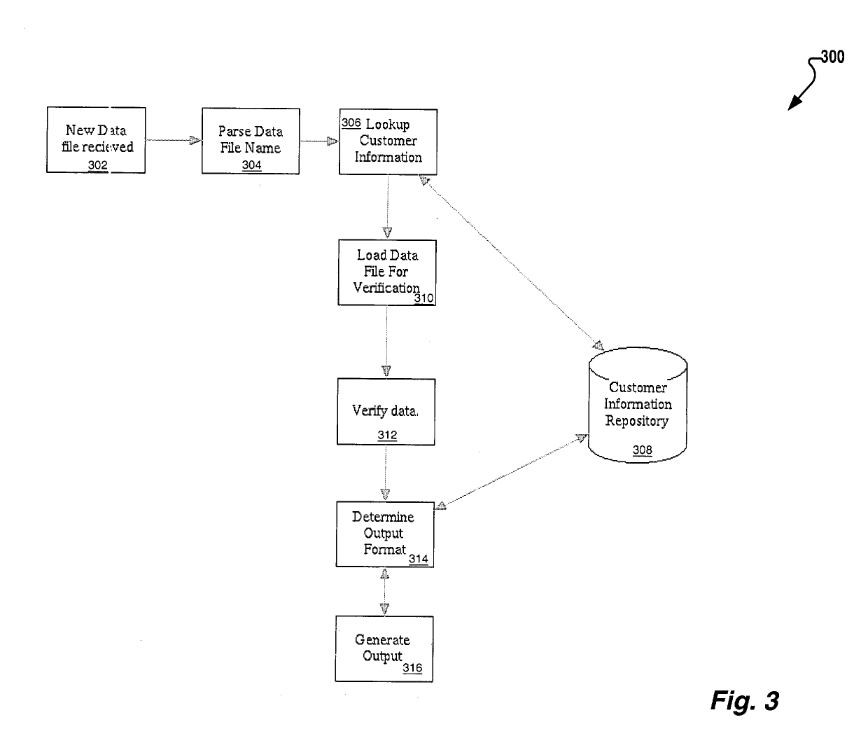

FIG. 3 illustrates an exemplary block diagram of a method 300 in accordance with an embodiment of the present invention. In an embodiment of the present invention, the method 300 may be utilized to assist in bulk loading of a customer's enterprise learning platform (ELP) instance database. Generally, a database as used herein is envisioned to include any collection of data that is organized for collection and/or retrieval. The ELP may be one provided by Sun Microsystems, Inc., of Santa Clara, Calif. The method 300 begins with a stage 302 in which a new data file is received, for example, from a customer. In a stage 304, the file name of the received file is parsed. If the parsing of the stage 304 fails, an error report may be created and forwarded to appropriate personnel at a customer and/or provider site. In accordance with an embodiment of the present invention, the information parsed by the stage 304 may be data stored within the received file and/or provided otherwise through a communication channel (such as those discussed with respect to the network interface 118 of FIG. 1). The parsed data may also be provided separately from the data file (for example, in a different file). In a stage 306, based on the successfully parsed information of the stage 304, customer information is looked up, for example, from a customer information repository 308.

In one embodiment of the present invention, the customer information repository 308 may reside on the LMS server 204 of FIG. 2. In various embodiment of the present invention, the customer information repository 308 may be implemented as a file and/or database. Generally, a database as used herein is envisioned to include any collection of data that is organized for collection and/or retrieval. It is, however, envisioned that the customer information repository 308 may reside on any storage media such as that discussed with respect to the FIG. 1 (e.g., the mass storage 114). If an error arises during the stage 306 (e.g., customer not in repository 308), an error report may be created and sent to appropriate personnel at a customer and/or provider site.

The method 300 continues in a stage 310 wherein the data file of the stage 302 is loaded for verification. The loading may be into a computer system such as that discussed with respect to FIG. 1 (for example, into the main memory 104). In a stage 312, the loaded data of the stage 310 is verified. If an error arises during the stage 312 (e.g., the data does not match the predefined format), an error report may be created and sent to appropriate personnel at a customer and/or provider site.

In accordance with an embodiment of the present invention, an LMS server (such as 204 of FIG. 2) may automatically check for new data at configurable intervals. An interval may range from several seconds to days depending on the implementation.

In accordance with another embodiment of the present invention, since each set of data may belong to an ELP customer, each incoming portion of the data file may be mapped to the appropriate customer by parsing the data file's name. In an embodiment of the present invention, a data file's name may conform to the following specification:

<custID>-<elpVersion>_<datestamp>.<bulkload_cmd>

where each item in ‘< >’s is a substituted value as follows:

custID: the ID of the customer the data file came from;

elpVersion: the version of ELP the customer is using;

datestamp: a date and/or time stamp, in the form of YYYYMMDD-HHMM (for example: 20021010-1213), (in one embodiment of the present invention, the files with the oldest date stamp may be processed first); and

bulkload_cmd: a code which identifies the type of data contained within the data file (it may be necessary to determine the type of data since a different bulk loader may be used for each different type of data in accordance with an embodiment of the present invention).

A couple of examples for valid file names are:

custABC-3.1_{—}20021010-1213.addstudent

custXYZ-2.6_{—}20010908-1710.removestudent

In a further embodiment of the present invention, the custID and elpVersion fields may be utilized to perform the stage 306 of FIG. 3. The customer information repository 308 may contain additional information associated with the custID and elpVersion. For each customer the additional information may include one or more of the following:

Customer ID;

ELP Version;

ELP Patch Level; and

Source Reader (indicating the appropriate and/or compatible data reader).

The stage 306 may look up a record by using the custID and elpVersion it found by parsing the input data file's name (stage 304). Using this information, an appropriate (or compatible) data file reader may be determined in a stage 314 and used to read/load the contents of the input file of the stage 302 in a stage 316.

In accordance with an embodiment of the present invention, in order to properly verify the data (stage 312), the ELP version and patch level of the customer data are taken into account (e.g., to ensure utilization of the proper set of verification rules). The patch level may be determined by looking it up in the customer information repository (308). The stage 312 may verify the data values to determine whether the correct data type and data length are present, as well as that all data fields required by the bulk loader are present.

Once the data has been successfully verified (312) and the appropriate output format determined (stage 314), the stage 316 converts the data to the format required by the bulk loader, which will be loaded into the ELP. In accordance with an embodiment of the present invention, the output format to be used is determined based on the type of bulk load, ELP version, and ELP Patch level.

In accordance with an embodiment of the present invention, extensible markup language (XML) may be utilized to implement various embodiments. In particular, customer data may be converted into XML using an XML schema or document type definition (DTD). During this process, input fields may be checked for length and validity (e.g., using the XML schema). Any input data, which cannot be validated, may be written to a log file and returned to the customer so they can correct the data as necessary. Input data, which has been validated, is then transformed (e.g., with the use of XML style sheets) into the valid input format of the bulk loader scripts being used. Also, if the bulk loader input format is changed, only the XML style sheets need to be updated and the customer no longer has to update their data format each time the bulk loader tools are modified.

The foregoing description has been directed to specific embodiments. It will be apparent to those with ordinary skill in the art that modifications may be made to the described embodiments, with the attainment of all or some of the advantages. For example, the techniques of the present invention may be applied to computer-based and/or electronic gaming technologies. In addition, an applet and other solutions may be utilized including, but not limited to, a stand-alone application, an object, a program, a procedure, and the like. Furthermore, the procedures to implement the invention may be written in a variety of computer languages such as Java, C, C++, Ada, LISP, and the like.

Also, the bulk loaders provided in accordance with various embodiment of the present invention are not envisioned to be limited to loading courseware management data and may load any combination of the following types of data (including profile data): student data, company data, student group data, course data (e.g., type of course, date of course, instructor, and the like), student course enrollment data, and/or company financial account data. Therefore, it is the object of the appended claims to cover all such variations and modifications as come within the spirit and scope of the invention.

What is claimed is:

1. A method of providing courseware data, the method comprising:
receiving a data file from a customer, the customer data including the courseware data;
parsing a data field associated with the data file;
looking up customer data associated with the parsed data field in a customer information repository, the customer information repository storing customer data corresponding to a customer ELP version and a customer ID;
verifying data stored in the data file;
determining an output format corresponding to the customer ELP version and the customer ID; and
generating an output by applying the determined output format to the customer data file.

2. The method of claim 1 wherein the verifying act includes checking one or more items selected from a group comprising data values, data types, data length, and required data fields.

3. The method of claim 1 wherein the verifying act includes verifying at least one of an ELP version and a patch level corresponding to the customer data.

4. The method of claim 3 wherein the patch level is determined by accessing the customer information repository.

5. The method of claim 1 further including loading looked up customer data into a main memory.

6. The method of claim 1 wherein the data field includes information selected from a group comprising a customer ID, a customer ELP version, a date stamp, and a bulk load command.

7. The method of claim 1 wherein the customer information repository stores additional information associated with the customer ID and ELP version selected from a group comprising ELP patch level and a source reader.

8. The method of claim 1 wherein the data field is selected from a group comprising a name of the data file, a data field stored in the data file, and a data field corresponding to the data file.

9. The method of claim 1 further including converting the customer data file into XML.

10. The method of claim 9 wherein the conversion is performed by using an XML item selected from a group comprising a schema, a DTD, and a style sheet.

11. The method of claim 9 wherein during the conversion:
a plurality of input fields are checked for an appropriate length and validity;
any input data which cannot be validated is written to a log file;
any input data which can be validated is transformed into a valid input format of a bulk loader used to generate the output; and
the log file is returned to the customer for further processing.

12. The method of claim 11 wherein the transformation is performed by an XML style sheet.

13. The method of claim 12 wherein if a format of the bulk loader is changed, only the XML style sheet need to be updated.

14. The method of claim 11 wherein the further processing includes correcting the data file.

15. The method of claim 11 wherein the plurality of input fields are checked using an XML schema.

16. The method of claim II wherein the customer is not required to update a format of the customer data file when the bulk loader is modified.

17. The method of claim 1 wherein an LMS periodically checks for presence of the customer data file.

18. The method of claim 1 wherein the data file includes information selected from a group comprising student data, company data, student group data, course data, student course enrollment data, and company financial account data.

19. The method of claim 18 wherein the course data includes information selected from a group comprising course type, course date, and instructor.

20. The method of claim 1 wherein the courseware data is provided in accordance with SCORM.

21. An article of manufacture comprising:
a machine readable medium that provides instructions that, if executed by a machine, will cause the machine to perform operations including:
receiving a data file from a customer, the customer data including courseware data;
parsing a data field associated with the data file;
looking up customer data associated with the parsed data field in a customer information repository, the customer information repository storing customer data corresponding to a customer ELP version and a customer ID;
verifying data stored in the data file;
determining an output format corresponding to the customer ELP version and the customer ID; and
generating an output by applying the determined output format to the customer data file.

22. The article of claim 21 wherein the operations further include loading looked up customer data into a main memory.

23. A computer system for providing courseware data, the computer system comprising:
means for receiving a data file from a customer;
means for parsing a data field associated with the data file;
means for looking up customer data associated with the parsed data field in a customer information repository;
means for verifying data stored in the data file;
means for determining an output format corresponding to a customer ELP version and a customer ID; and
means for generating an output by applying the determined output format to the customer data file.

24. A computer system for providing courseware data, the computer system comprising:
a client apparatus to provide a customer data file;
an LMS server to store the courseware data and receive the customer data file, the LMS server and the client apparatus communicating through a communication channel; and
a customer information repository to store data corresponding to a customer ELP version and a customer ID, the customer information repository being accessible by the LMS server,
wherein a data field associated with the customer data file is parsed to determine an output format corresponding to the customer ELP version and the customer ID.

25. The computer system of claim 24 wherein the communication channel is selected from a group comprising Ethernet, Fast Ethernet, WAN, leased line, OC3, DSL, cellular, wireless, TDM, ATM, satellite, analog modem, cable modem, USB, and FireWire.

26. The computer system of claim 24 wherein the data field includes information selected from a group comprising a customer ID, a customer ELP version, a date stamp, and a bulk load command.

27. The computer system of claim 24 wherein the customer information repository stores additional information associated with the customer ID and ELP version selected from a group comprising ELP patch level and a source reader.

28. The computer system of claim 24 wherein the data field is selected from a group comprising a name of the data file, a data field stored in the data file, and a data field corresponding to the data file.

29. The computer system of claim 24 wherein the customer information repository is stored on the LMS server.

30. The computer system of claim 24 wherein the data file includes information selected from a group comprising student data, company data, student group data, course data, student course enrollment data, and company financial account data.

31. The computer system of claim 30 wherein the course data includes information selected from a group comprising course type, course date, and instructor.

32. The computer system of claim 24 wherein the courseware data is provided in accordance with SCORM.
